(19) United States
(12) Patent Application Publication
(10) Pub. No.: US 2012/0104330 A1
(43) Pub. Date: May 3, 2012

(54) METAL INK COMPOSITION, METHOD OF FORMING A CONDUCTIVE METAL FILM USING THE SAME, AND CONDUCTIVE METAL FILM USING THE SAME

(75) Inventors: Yun Hyuk CHOI, Seoul (KR); Young Hun BYUN, Seoul (KR); Jae Ho LEE, Yongin-si (KR); Suk Jun KIM, Suwon-si (KR)

(73) Assignee: SAMSUNG ELECTRONICS CO., LTD., Suwon-si (KR)

(21) Appl. No.: 13/253,349

(22) Filed: Oct. 5, 2011

(30) Foreign Application Priority Data
Nov. 2, 2010 (KR) 10-2010-0108121

(51) Int. Cl. H01B 1/02; B05D 5/12; B05D 3/02; B05D 1/30; B05D 1/02; B05D 1/28; B05D 1/18; H01B 1/12; B05D 3/12

(52) U.S. Cl. 252/512; 252/519.2; 427/123

(57) ABSTRACT

Provided herein is a metal ink composition, including an organism-derived adhesive material. Such a metal ink composition is eco-friendly and is adhered to an adherent with excellent adhesion even when added in a small content. Further, the metal ink composition is not condensed by thermal sintering, and thus exhibits excellent patternability.

### CROSS-REFERENCE TO RELATED APPLICATION

This application claims priority to Korean Patent Application No. 10-2010-0108121, filed on Nov. 2, 2010, and all the benefits accruing therefrom under 35 U.S.C. §119, the content of which in its entirety is herein incorporated by reference.

### BACKGROUND

1. Field

This disclosure relates to a metal ink composition, a method of forming a conductive metal film using the same, and a conductive metal film using the same.

2. Description of the Related Art

Metal interconnections are a desirable method for electrically connecting semiconductor devices and discrete devices, such as transistors, to one another. Currently, in accord with a trend of more highly integrated semiconductor devices, in an electronic device such as an integrated circuit or a liquid crystal display device, the degree of integration of the devices is being increased. Further, as the devices become small and increasingly compact, the dimensions of the metal interconnection patterns are becoming finer.

To form finer metal interconnection patterns, i.e., patterns having smaller dimensions, commercial photolithographic processes use a photoresist. In a commercially practiced photolithographic method, after a metal material layer, which is a base of an interconnection, is formed on a substrate by chemical vapor deposition (“CVD”), plasma deposition, or electroplating, a photoresist is applied onto the metal material layer, and the photoresist is exposed and developed using a photomask, thereby forming a metal layer having the patterned photoresist layer. Afterwards, the metal layer is etched by reactive ion etching to provide a metal interconnection having a fine-pattern on the substrate.

As an alternative to photolithography, soft lithography and inkjet printing, which are capable of forming a fine pattern on a substrate in a simpler process, have attracted attention. These simple and convenient methods can form a fine metal pattern at a lower cost.

Hence, metal ink employed in an inkjet printing or gravure off-set process to form a metal interconnection and so forth is actively being manufactured.

### SUMMARY

Exemplary embodiments provide a metal ink composition with excellent printability, which may be used to manufacture a conductive metal film with excellent adhesion to a substrate.

In an aspect, a metal ink composition includes metal particles or a metal precursor, a solvent, and an adhesive material derived from an organism (an “organism-derived adhesive material”).

The organism-derived adhesive material may be, for example, a compound (A) of Formula 1, or a compound (B) having a structure in which a moiety derived from the compound (A) is chemically bonded to a unit of the main chain of a water-soluble compound (b):

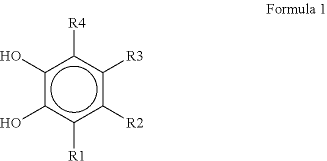

wherein

R1, R2, R3, and R4 are each independently hydrogen or —R—X and two of R1, R2, R3, and R4 form a C₃-C₆ ring structure by bonding to each other, each R may be a C₁-C₁₀ alkyl, C₂-C₁₀ alkenyl, C₃-C₁₀ alkynyl, or C₁-C₁₀ alkoxy, each of which may be unsubstituted or substituted with —OH or —COOH, each —X may be —NR′R″, —COOR′, —NH₂COOR′, —CONR′R″, —OR′, phenyl or benzyl, wherein R′ and R″ may each independently be hydrogen or C₁-C₃ alkyl, and wherein the two of R1, R2, R3, and R4, that form a ring structure by bonding to each other may form a C₃-C₆ cycloalkyl, C₃-C₆ heterocycloalkyl, C₄-C₆ aryl, or C₄-C₆ heteroaryl, each of which may be unsubstituted or substituted with —R—X, —OH or —COOH.

In another aspect, a method of preparing the metal ink composition described above is provided.

For example, in an embodiment, the method of preparing the metal ink composition may include dissolving a metal or metal precursor in a solvent to form a first solution; dissolving a compound (A) of Formula 1 or a compound (B) having a structure in which the compound (A) is chemically bonded to a unit of the main chain of a water-soluble compound (b), in water and/or alcohol to form a second solution; and combining the first solution with the second solution. Here, the definition of Formula 1 is as described above.

In still another aspect, a method of forming a conductive metal film using the above-described metal ink composition is provided.

In an embodiment, the method of forming the conductive metal film includes providing a substrate, disposing the metal ink composition as disclosed above on the substrate to prepare a coated substrate, and heating the coated substrate to form the conductive metal film.

The metal ink composition may be coated on the substrate to provide a pattern.

To coat the metal ink composition on the substrate, a method such as spin coating, roll coating, deep coating, spray coating, dip coating, flow coating, doctor blade, dispensing, inkjet printing, screen printing, gravure printing, offset printing, pad printing, flexography printing, stencil printing, imprinting, xerography, or lithography may be used.

In yet another aspect, a conductive metal film is provided, which is formed by coating the above-described metal ink composition on a substrate and heating the substrate.

In another embodiment, a conductive metal film comprises a substrate; and a product of heating the metal ink composition on the substrate.

### BRIEF DESCRIPTION OF THE DRAWINGS

The above and other aspects of the disclosure will become more readily apparent by describing in further detail example embodiments thereof which reference to the accompanying drawings, in which:

FIG. 1 is a graph of resistivity (microohm centimeters, μΩ·cm) versus type of adhesive material comparing conductivity versus the type of an adhesive material according to Experimental Example 2; and

FIG. 2 is a graph of resistivity (microohm centimeters, μΩ·cm) versus content of adhesive material (weight of adhesive material versus the total weight of the metal particles and the metal precursor, if present, “wt % to copper”) comparing conductivity according to the content of an adhesive material according to Experimental Example 3.

### DETAILED DESCRIPTION

Various representative embodiments will now be further disclosed with reference to the accompanying drawings in which some exemplary embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. In the drawings, the thicknesses of layers and regions may be exaggerated for clarity. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups including at least one of the foregoing.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, unless otherwise provided, the term “substituted” refers to a compound or radical substituted with at least one (e.g., 1, 2, 3, 4, 5, 6 or more) substituents independently selected from a halogen (e.g., F, Cl, Br, I), amine, hydroxyl, thiol, cyano, sulfonyl, or a combination including at least one of the foregoing, instead of hydrogen, provided that the substituted atom's normal valence is not exceeded.

The term “alkyl” refers to a straight or branched chain, saturated aliphatic hydrocarbon group having the indicated number of carbon atoms. The alkyl group may have 1 to 10 carbon atoms. For example, a C₁-C₄ alkyl group may includes 1 to 4 carbon atoms in an alkyl chain. The C₁-C₄ alkyl group is selected from a methyl, ethyl, propyl, iso-propyl, n-butyl, iso-butyl, sec-butyl, or t-butyl group. An alkyl group includes, for example, methyl, ethyl, propyl, isopropyl, butyl, isobutyl, t-butyl, pentyl, hexyl, ethenyl, propenyl, butenyl, cyclopropyl, cyclobutyl, cyclopentyl, cyclohexyl, and the like, but is not limited thereto.

The term “alkenyl” refers to a straight or branched chain hydrocarbon group having the indicated number of carbon atoms and at least one carbon-carbon double bond.

The term “alkynyl” refers to a straight or branched chain hydrocarbon group having the indicated number of carbon atoms and having at least one carbon-carbon triple bond.

The term “alkoxy” refers to an alkyl group having the indicated number of carbon atoms and that is linked via an oxygen (i.e., alkyl-O—), for example methoxy, ethoxy, and sec-butyloxy groups. The alkoxy group may have 1 to 10 carbon atoms.

The term “cycloalkyl” refers to a monovalent group having one or more saturated rings in which all ring members are carbon (e.g., cyclopentyl and cyclohexyl). The cycloalkyl group may be an unsaturated aliphatic 3 to 10-membered ring, specifically a cyclohexyl group.

“Arene” means. Specific arenes include benzene, naphthalene, toluene, and xylene.

The term “aryl” refers to a hydrocarbon group having an aromatic ring, and includes monocyclic and polycyclic hydrocarbons wherein the additional ring(s) of the polycyclic hydrocarbon may be aromatic or nonaromatic (e.g., phenyl or napthyl). Aryl includes monocyclic or fused ring polycyclic groups (that is, rings sharing adjacent pairs of carbon atoms). The aryl group may be a 4 to 10-membered, specifically a 6 to 10-membered, aromatic monocyclic or multicyclic ring group.

The prefix “hetero” means that the compound or group includes at least one heteroatom (e.g., 1, 2, or 3 heteroatom(s)), wherein the heteroatom(s) are each independently N, O, S, Si, or P. In a heterocycloalkyl or heteroaryl group, the one or more heteroatoms form part of the ring.

Representative heteroaryl groups include groups having an aromatic 4 to 8-membered or 5 to 6-membered ring and including one to three hetero atoms in which at least one carbon (C) in the ring structure is replaced with nitrogen (N), phosphorus (P), oxygen (O), or sulfur (S) and is capable of being fused with benzo or C₃ to C₈ cycloalkyl. Examples of a monocyclic heteroaryl may include, but are not limited to groups derived from, thiazole, oxazole, thiophene, furan, pyrrole, imidazole, isooxazole, pyrazole, triazole, thiadiazole, tetrazole, oxazole, pyridine, pyridazine, pyrimidine, pyrazine, and the like. Examples of a multi-cyclic heteroaryl may include, but are not limited to groups derived from indole, indoline, benzothiophene, benzofuran, benzimidazole, benzoxazole, benzisooxazole, benzothiazole, benzothiadiazole, benzotriazole, quinoline, isoquinoline, purine, furopyridine, and a similar group thereof.

Representative heterocycloalkyl groups include a 4 to 8-membered or 5 to 6-membered ring including one to three hetero atoms in which at least one C in a ring structure is replaced with N, P, O, or S, and is capable of being fused with benzo or C₃ to C₈ cycloalkyl. Examples of a heterocycloalkyl may include, but are not limited to, furan, thiophene, pyrrole, pyrroline, pyrrolidine, oxazole, thiazole, imidazole, imidazoline, imidazoline, pyrazole, pyrazoline, pyrazolidine, isothiazole, triazole, thiadiazole, pyrane, pyridine, piperidine, morpholine, thiomorpholine, pyridazine, pyrimidine, pyrazine, piperazine, triazine, and hydrofuran.

### 1. Metal Ink Composition

According to an embodiment, an ink composition includes a metal precursor, a solvent, and an organism-derived adhesive material.

The organism-derived adhesive material may be, for example, a compound (A) of Formula 1, or a compound (B) in which the compound (A) is chemically bonded to a unit of the main chain of a water-soluble compound (b).

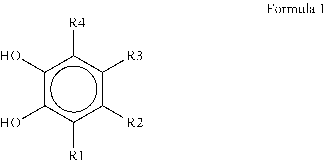

In Formula 1, R1, R2, R3, and R4 are each independently hydrogen or —R—X and two of R1, R2, R3, and R4 form a C₃-C₆ ring structure by bonding to each other.

Each R may independently be a C₁-C₁₀ alkyl, a C₂-C₁₀ alkenyl, a C₃-C₁₀ alkynyl, or a C₁-C₁₀ alkoxy, each of which is unsubstituted or unsubstituted with —OH or —COOH.

Each X may independently be —NR′R″, —COOR′, —NH₂COOR′, —CONR′R″, —OR′, phenyl, or benzyl, wherein R′ and R″ may be independently hydrogen or C₁-C₃ alkyl.

When any of the two of R1, R2, R3 and R4 are formed in a ring structure by bonding to each other, they may form a C₃-C₆ cycloalkyl, C₃-C₆ heterocycloalkyl, C₄-C₆ aryl, or C₄-C₆ heteroaryl, each of which is unsubstituted or with —R—X, —OH or —COOH.

In these embodiments of an ink composition, the organism-derived adhesive material, that is, the compound (A) of Formula 1, and the compound (A)-derived compound (B) have a catechol (C₆H₄(OH)₂) group, which includes two hydroxyl groups and a functional group (X) on or as a side chain. Without being bound by theory, it is believed that these functionalities contribute to adhesion with other organic or inorganic materials.

Thus, the ink composition including the adhesive material, even when added in a small amount, has excellent adhesion to a substrate and a surface treatment of the substrate may be omitted.

In a commercially available metal ink or paste, although a silver ink containing silver (Ag) nanoparticles has been mainly used, the use of a copper (Cu) ink is preferable in terms of cost. In the Cu ink including Cu nanoparticles or a Cu precursor, the adhesion to the substrate, particularly, to a glass substrate, is very poor. Hence, an ink technology containing a polymer adhesive such as PVP or ethyl cellulose as an adhesion aid has been suggested. However, these industrial polymer adhesives have problems of condensation during rapid thermal plasticization.

Unlike the conventional industrial polymer adhesives, the disclosed adhesive material is not condensed or thermally condensed even by rapid thermal plasticization, and thus provides greatly improved printability and adherability to a substrate. Further, even if a smaller amount of the adhesive material is added, the adhesion may be greatly improved.

In an embodiment, in the compound (A) of Formula 1, each of R1, R2, R3, and R4 may independently be C₁-C₅ alkyl, C₂-C₅ alkenyl, C₃-C₅ alkynyl, or C₁-C₅ alkoxy, each of which may be independently unsubstituted or substituted with —OH or —COOH. In another embodiment each of R1, R2, R3, and R4 may each independently be unsubstituted C₁-C₃ alkoxy, or C₁-C₃ alkyl or C₂-C₃ alkenyl, each of which may be independently unsubstituted or substituted with —OH.

In an embodiment, the substituent —X may be —NH₂, —COOH, —NH₂COOR′, —CONH, or —OH, wherein each R′ may independently be hydrogen or C₁-C₃ alkyl. In one example, the substituent —X may be —NH₂, —COOH, —NH₂COOH, or —OH. The substituent —X may be a functional group capable of being chemically bonded to a unit of the main chain of the water-soluble compound (b).

As examples of the compound (A) of Formula 1, the following compounds of Formulas (i) to (xi) may be used, but are not limited thereto.

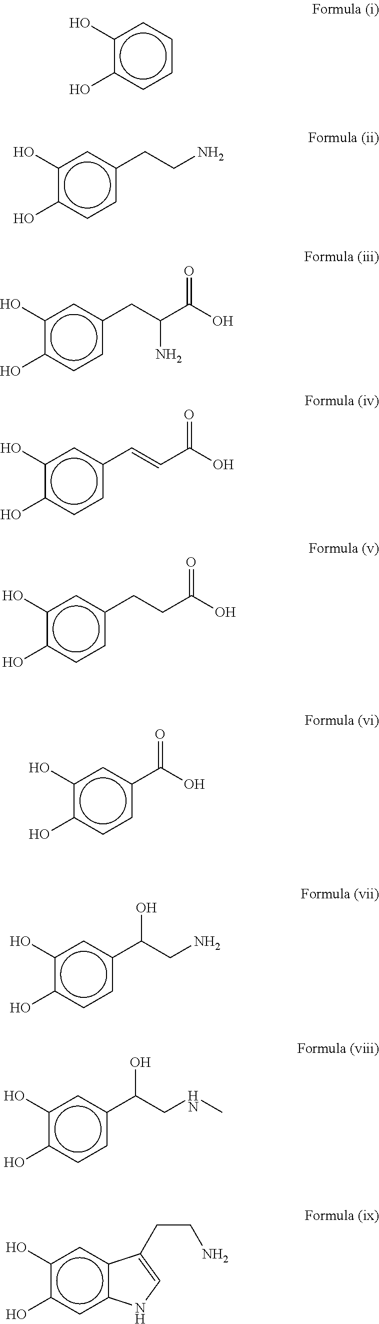

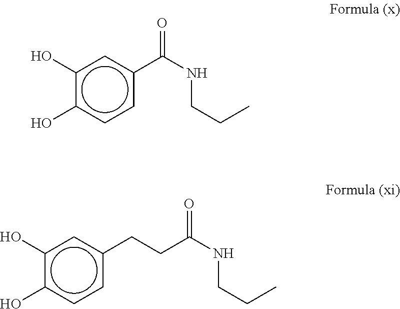

Compound (A) of Formula 1 is an organism-derived material, which is biologically and ecologically friendly. For example, the compound (A) may be a material derived from an organism, which includes a wide variety of individual life forms, including, multicellular organisms such as plants, fish, insects, crustaceans, most fungi, or algae, single-cell organisms such as yeasts, some fungi, bacteria, protists such as amoebas, or viruses, and materials derived from organisms, for example a protein derived from a cell or tissue of a human body, or a protein of a viscous material of an animal such as mucus. An “organism-derived material” is thus inclusive of a material derived directly from an organism (e.g., extracted from an algae), or derived indirectly from an organism (e.g., produced in a tissue culture).

In an example, catechols such as 1,2-catechol, which is the compound of Formula (I), may be derived from fruits or vegetables. Also the dopamine of Formula (II) or the 3,4-dihydroxy-phenylalanine (which includes 3,4-dihydroxy-L-phenylalanine (“L-DOPA”)) of Formula (iii) may be extracted from the mucus of a marine organism, such as mussels. The caffeinic acid of Formula (Iv) or the hydrocaffeinic acid of Formula (v) may be derived from a plant material, such as coffee beans. The 3,4-dihydroxy benzoic acid of Formula (vi) may be derived from birch bark. The norepinephrine of Formula (vii) or the epinephrine of Formula (viii) may be derived from a plant such as acanthopanax.

The water-soluble compound (b), from which the main chain of the compound (B) is derived, is fully soluble in water, is miscible with metal particles or a metal precursor, and can be chemically bonded, i.e., functionalized with the compound (A) of Formula 1. The substituent —X in the compound (A) of Formula 1 may include a functional group such as an amine group, a carboxyl group, or a hydroxyl group, and thus the compound (A) of Formula 1 may be used to provide a cationic polymer (B), for example, by derivatizing a cationic polymer (b) with these functional groups.

In an embodiment, the water-soluble compound (b) may be a hyaluronic acid, a polyethylene imide (“PEI”), or a polyethylene glycol (“PEG”). These water-soluble compounds (b) are ecologically friendly water-soluble polymers.

In an embodiment, the compound (B), in which the compound (A) is chemically bonded to the main chain of the water-soluble compound (b), may be, for example, a hyarulonic acid chemically bonded with dopamine, which is the compound of Formula (b1); a 3,4-dihydroxy benzoic acid-bonded PEI, which is the compound of Formula (b2); or a hydrocaffeinic acid-bonded PEI, which is the compound of Formula (b3). In the compound of Formula (b1), the n and m blocks may be randomly or non-randomly arranged, and in an embodiment may be arranged in blocks.

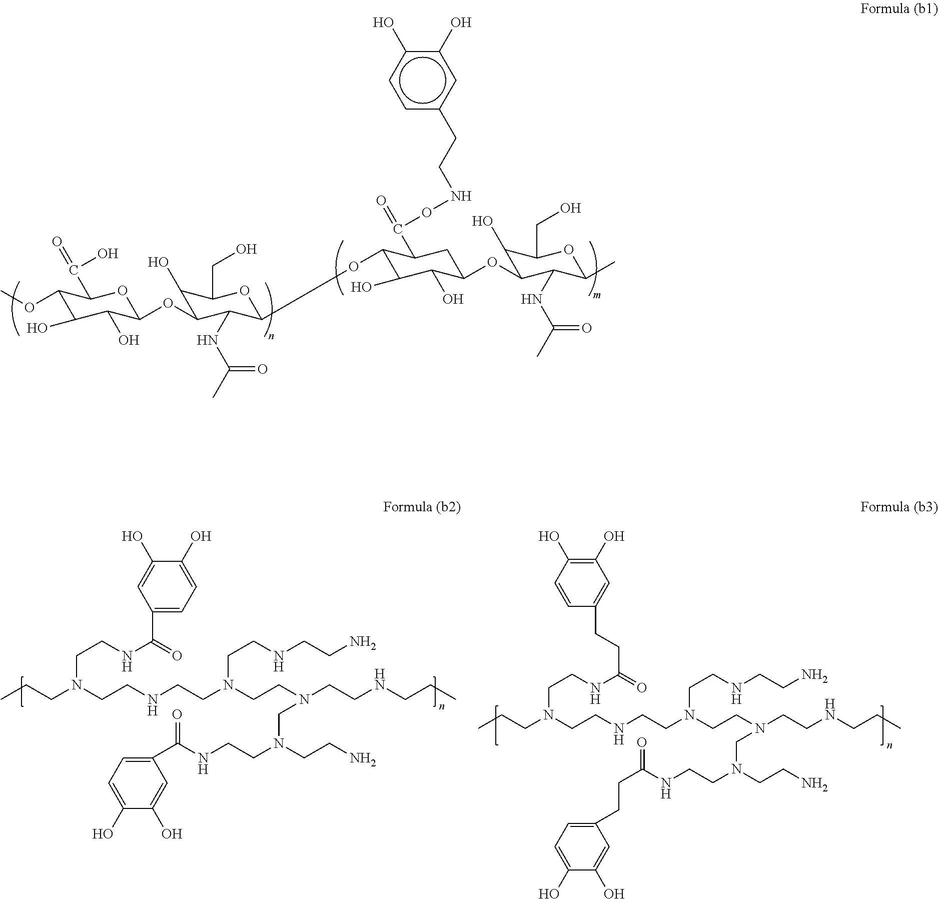

A concentration of the compound (A) to be bonded to the water-soluble compound (b) may be about 0.1 to about 50 mol %, or about 0.5 to about 40 mol %, or about 1 to about 30 mol %, based on the moles of repeat units in the main chain of the compound (b).

A molecular weight (“MW”) of the compound (A) of Formula 1, or a weight average molecular weight (“MW”) the water-soluble compound (b), may be about 100 to about 100,000 Daltons, or about 200 to about 75,000 Daltons, or about 400 to about 50,000 Daltons.

A content of the compound (A) of Formula 1 or the content of the compound (A)-bonded compound (B) may be about 3.7 to about 10 weight percent (wt %), or about 4 to about 9 wt %, or about 5 to about 8 wt %, based on the total weight of the metal particles or the metal precursor in the metal ink composition. If the content is less than about 3.7 wt %, the binding ability and adhesion to the substrate may be decreased, and if the content is more than about 10 wt %, the conductivity may be decreased.

In the metal ink composition, the metal may be at least one selected from gold, silver, nickel, indium, zinc, titanium, copper, chromium, tantalum, tungsten, platinum, iron, cobalt, and an alloy thereof. A combination comprising at least one of the foregoing can be used. A metal included in the metal ink may be in the form of metal particles, or a metal precursor capable of being reduced to the metal.

As the size (e.g., average largest particle size) of the metal particles is decreased, it is easier to discharge the metal ink from an inkjet nozzle. Therefore, metal nanoparticles having a size (e.g. average largest particle size) of about 500 nm or less, or about 200 nm or less, or about 50 nm or less have a desirable influence on forming drops in the discharge of the inkjet.

The metal precursor is a compound including a metal atom. For example, the metal precursor includes an organo-metallic compound having a carbon-metal bond, a metal-organic compound including an organic ligand bound to the metal through an atom other than carbon such as oxygen, nitrogen, or sulfur, or an inorganic compound. A combination comprising at least one of the foregoing can be used. The inorganic compound may include, but is not limited to, a metal nitride, or a metal salt such as a metal halide, a metal sulfide, a metal hydroxide, or a metal carbonate. A combination comprising at least one of the foregoing can be used.

For example, a metal precursor compound, which may provide a metal by removal a ligand by a radical mechanism during conversion into the metal, may be used as the metal precursor. A compound containing a ligand which can be completely removed during the conversion into the metal may be used as the metal precursor.

In addition, a precursor in the form of a complex metal salt containing a neutral inorganic or organic ligand may be used. For example, the precursor may also be in the form of nitrate, halide, perchlorate, hydroxide, or tetrafluoroborate, but the precursor is not limited thereto.

In an embodiment, the metal precursor may be a metal formate, such as copper formate. The metal formate may be reduced and then degraded by heat, evolving a volatile material, e.g., CO₂, CO, or H₂O, as a degradation product. Hence, only a gas-phase byproduct, which may protect copper formed in-situ from oxidation, may be formed. A gas-phase a byproduct is easily removed, and thus does not remain in the formed copper layer. Since a reducing agent, e.g., an aldehyde, is generated, the reduction of a metal ion to a metal may be performed with a high yield without the addition of a separate reducing agent by heat treatment. Further, the degradation temperature of the metal organic precursor may be decreased. Therefore, a high-purity metal film or pattern may be formed at a low temperature.

In the ink composition, the content of the metal particles or metal precursor is not particularly limited, and thus, for example, may be included up to the limit of solubility of the metal particles or the metal precursor with respect to a solvent. However, if the content of the metal particles or metal precursor is less than about 20 parts by weight, the metal content is insufficient, and thus the metal particles or metal precursor are not readily used as the interconnection in various ways and usefulness thereof is limited, and if the content exceeds about 85 parts by weight, a viscosity is very high, and thus a discharging ability may be degraded. The content of the metal particles or the metal precursor in the ink composition may be in a range of about 50 to about 70 parts by weight, or about 55 to about 65 parts by weight, or about 60 parts by weight, based on the total weight of the metal ink composition, to maintain the metal content at a high concentration and facilitate the flowability of the ink.

The term “solvent” may refer to a compound capable of partially dissolving and/or suspending at least a portion of the metal particles or metal precursor. Such a solvent may be selected from water; an amine solvent such as a primary amine such as propylamine, n-butylamine, hexylamine, or octylamine, a secondary amine such as diisopropylamine or di(n-butyl)amine, a tertiary amine such as trioctylamine or tri-n-butylamine, an alkyl amine such as ethylamine, propylamine, butylamine, hexylamine, octylamine, or trioctylamine, or a cyclic amine or aromatic amine; an ester solvent such as propylene glycol-1-monomethyl ether-2-acetate (“PEGMEA”), ethyl acetate, n-butyl acetate, γ-butyrolactone, 2,2,4-trimethylpentadiol-1,3-monoisobutyrate, butyl carbitol acetate, butyl oxalate, dibutyl phthalate, dibutyl benzoate, butyl cellosolve acetate, or ethylene glycol diacetate; a ketone solvent such as acetone, methylethylketone, methylisobutylketone, or cyclohexanone; an aliphatic or aromatic hydrocarbon solvent such as toluene, xylene, aromasol, chlorobenzene, hexane, cyclohexane, decane, dodecane, tetradecane, hexadecane, octadecane, octadecene, nitrobenzene, or o-nitrotoluene; an ether solvent such as diethylether, dipropyl ether, dibutyl ether, dioxane, tetrahydrofuran, octyl ether, or tri(ethylene glycol) dimethyl ether; an alcohol such as methanol, ethanol, 1-propanol, 2-propanol, 1-butanol, 2-butanol, isobutanol, hexanol, isopropyl alcohol, ethoxy ethanol, ethyl lactate, octanol isoporpylalcohol, ethyleneglycol monomethylether, benzyl alcohol, 4-hydroxy-3-methoxy benzaldehyde, isodeconol, butylcarbitol, terpineol, alpha-terpineol, beta-terpineol, or cineol; a polyol such as glycerol, glycol, ethylene glycol, diethyl glycol, triethylene glycol, tetraethylene glycol, propylene glycol, dipropylene glycol, butanediol, hexylene glycol, 1,2-pentadiole, 1,2-hexadiol, glycerin, polyethylene glycol, polypropylene glycol, ethyleneglycol monomethylether (e.g., methyl cellusolve), ethyl eneglycol monoethylether (e.g., ethyl cellusolve), ethylene glycol monobutylether (e.g., butyl cellusolve), diethylglycol monoethylether, or diethylglycol monobutylether; an amide such as N-methyl-2-pyrollidone (“NMP”), 2-pyrrolidone, N-methylformamide, N,N-dimethyl formamide, or N,N-dimethyl acetamide; a sulfone or sulfoxide solvent such as diethylsulfone, tetramethylene sulfone, dimethyl sulfoxide, or diethylsulfoxide. A combination including at least one of the foregoing can be used.

In an example, as a non-aqueous solvent, for example, hexane, octane, decane, undecane, tetradecane, hexadecane, 1-hexadecene, 1-octadecene, hexylamine, or bis-2-ethylhexylamine may be used. The foregoing solvents may be used alone or a combination of at least one of the foregoing.

Since the solvent in the metal ink has a major effect on a drying speed of ink interconnection discharged from the substrate, it may be blended to have a drying characteristic suitable for the inkjet using a difference between a boiling point (“BP”) and a freezing point (“FP”) of the solvent. For example, a solvent having a high boiling point such as 1-octadecene may extend a working lifespan of the composition and delay a drying speed due to a low vapor pressure, and a solvent having a low boiling point such as bis-2-ethylhexylamine may increase the drying speed. Therefore, using such a mixed solvent, the print formation may be rapidly performed.

A content of the solvent may be about 10 to about 70 parts by weight, or about 15 to about 65 parts by weight, or about 20 to about 60 parts by weight, based on the total weight of the metal ink composition, and to have the metal concentration at a high level, it is preferable that the minimum amount of an organic solvent is used. When the content of the solvent is less than 10 parts by weight, due to a high drying speed of an inkjet head, a nozzle plugging phenomenon may occur and it is difficult to ensure the dispersion stability of particles. However, when the content is more than 70 parts by weight, even with a relatively small metal content, a metal film may not be reliably formed.

If desired, the metal ink composition may further include a stabilizer, a dispersant, a binder, a reducing agent, a surfactant, a wetting agent, a thixotropic agent or leveling agent, or an adhesive such as a conductive adhesive.

The stabilizer may be, but is not limited to, an amine such as primary amine, a secondary amine, or a tertiary amine, a bicarbonate compound such as an ammonium carbamate, ammonium carbonate, or an ammonium bicarbonate, a phosphorous compound such as a phosphine or phosphite, a sulfur compound such as a thiol or a sulfide, or a combination including at least one of the foregoing.

The dispersant may be 4000 series dispersant available from EFKA, a DISPERBYK® series dispersant available from BYK, a SOLSPERSE® series available from Avecia, a TEGO® DISPERS series dispersant available from Degussa, a DISPERSE-AYD® series dispersant available from Elementis, or a JONCRYL® series available from Johnson Polymer. A combination comprising at least one of the foregoing can be used.

The binder may be an acrylic resin, such as polyacrylate or ester polyacrylate, a cellulose resin, such as ethyl cellulose, cellulose ester, or cellulose nitrate, an aliphatic and co-polymeric polyester resin, a vinyl resin such as polyvinylbutyral, polyvinylacetate, or polyvinylpyrrolidone, a polyamide resin, a polyurethane resin, a polyether and urea resin, an alkyd resin, a silicon resin, a fluorine resin, an olefin resin such as polyethylene or polystyrene, a thermoplastic resin such as a petroleum or a rosin resin, or an epoxy resin, an unsaturated or vinyl polyester resin, a diallylphthalate resin, a phenol resin, an oxetane resin, an oxazine resin, a bismaleimide resin, a denatured silicon resin such as silicon epoxy or silicon polyester, a thermosetting resin such as a melamine resin, an ultraviolet or electron beam curing acrylic resin, an ethylene-propylene rubber (“EPR”), styrene-butadiene rubber (“SBR”), or a natural polymer such as starch or gelatine. As the binder, a combination comprising least one of the foregoing may be used. In addition to the organic resin binder, an inorganic binder such as a glass resin or a glass frit, a silane coupling agent, such as trimethoxy propyl silane or vinyl triethoxy silane, or a titanium-, zirconium- or aluminum coupling agent may also be used.

The surfactant may be an anionic surfactant such as sodium lauryl sulfate, a non-ionic surfactant such as nonyl phenoxy-polyethoxyethanol, or a ZONYL® FSN material available from DuPont, a cationic surfactant such as laurylbenzylammonium chloride, or an amphoteric surfactant such as lauryl betaine or coco betaine. A combination comprising at least one of the foregoing can be used.

The wetting or dispersing agent may be a compound such as polyethyleneglycol, a SURFYNOL® series agent available from Air Products, or a TEGO® wet series agent available from Degussa. A combination comprising at least one of the foregoing can be used.

The thixotropic or leveling agent may be BYK series available from BYK, a TEGO Glide® series additive available from Degussa, an EFKA 3000® series additive available from EFKA, or DSX® series additive available from Cognis. A combination comprising at least one of the foregoing can be used.

The conductive agent may be a transition metal such as Ag, Au, Cu, Ni, Co, Pd, Pt, Ti, V, Mn, Fe, Cr, Zr, Nb, Mo, W, Ru, Cd, Ta, Re, Os, or Ir, a main group metal such as Al, Ga, Ge, In, Sn, Sb, Pb, or Bi, a lanthanide metals such as Sm or Eu, an actinide metal such as Ac or Th, or an alloy or alloy oxide thereof. A combination comprising at least one of the foregoing can be used. The conductive agent may also be a conductive polymer such as conductive carbon black, graphite, carbon nanotube, polyacetylene, polypyrrole, polyaniline, polythiophene, or a derivative thereof.

The viscosity of the composition is not particularly limited, and may be a viscosity suitable for the manufacture of a thin film or a printing method, and may be for example, about 1 milliPascal seconds (mPa·s) to about 1000 Pascal seconds (Pa·s), or about 5 mPa·s to about 500 Pa·s.

### 2. Method of Preparing Metal Ink Composition

According to an embodiment, a method of preparing the metal ink composition including the following steps is provided. Formula 1, below, is as described above.

The method includes obtaining a first solution by dissolving a metal or metal precursor in a solvent; obtaining a second solution by dissolving a compound (A) of Formula 1 or a compound (B) in which the compound (A) is bonded to the main chain of a water-soluble compound (b), as the organism-derived adhesive material in water and/or alcohol; and combining the first solution with the second solution.

The solvent used for the first solution is the same as described above.

In an embodiment, in the second solution of the metal ink composition the adhesive material is soluble in water and/or an alcohol, and thus may be suitably applied to provide alcohol-containing ink. The alcohol may be ethylene glycol (“EG”).

### 3. Method of Forming a Conductive Metal Film

According to another embodiment, a method of forming a conductive metal film using the above-described composition for the metal ink and a conductive metal film formed thereby are provided. The conductive copper layer may be applied to provide an electronic device or a component for an electronic device, for example an electrode, a metal interconnection, a gate electrode of a semiconductor, or a gate electrode or source or drain electrode of liquid crystal display device, or an electrode of a circuit.

The method of forming the conductive metal film may include providing a substrate, coating the metal ink composition on the substrate, and applying heat to the substrate coated with the ink composition. The conductive metal film may be, for example, formed by coating the metal ink composition on a substrate and then applying heat thereto.

“Substrate” as used herein means any adherend for the metal ink composition, and can be of any material, organic or inorganic or any shape, e.g., flat or patterned. In an embodiment the substrate may comprise, but is not limited to, a semiconductor substrate, a metal, a silicon wafer, a glass, a ceramic, an inorganic substrate, polyimide (“PI”), polyethylene naphthalate (“PEN”), polyethylene terephthalate (“PET”), polyethersulfone (“PES”), polypropylene (“PP”), oriented PP (“oPP”), cycloolefin-based polymer, polycarbonate (“PC”), a polymer substrate, a rubber sheet, or a cellulose substrate such as fiber, wood, or paper. A combination comprising at least one of the foregoing can be used.

Such a substrate does not need specific treatment, but if desired, may be used after washing and oil-removal, and/or pretreatment. The pretreatment may be performed using plasma, ion beam, corona, oxidation or reduction, heat, etching, ultraviolet ray, or by treatment with a primer including a binder or an additive. In an embodiment, the pretreatment for improving adhesion may be omitted because of the excellent adhesion to a substrate without such a pretreatment.

The metal ink composition may be disposed, e.g., coated on an entire or a partial surface of the substrate, and if desired, may be patterned. To dispose, e.g., coat the metal ink composition on the substrate, spin coating, roll coating, deep coating, spray coating, dip coating, flow coating, doctor blade, dispensing, inkjet printing, screen printing, gravure printing, offset printing, pad printing, flexography printing, stencil printing, imprinting, xerography, or lithography may be used, but the disclosure is not limited thereto.

In the heat application process, a high-purity metal film may be formed through reduction to provide a metal or degradation of the organic material by heating. The heating may have a temperature of about 180° C., 160° C., 150° C., 130° C., 120° C., 100° C. or lower, and the heating may be performed in a substantially inert or in a reducing atmosphere, or in an atmosphere having oxygen partial pressure, or in air. In an embodiment, the heating is at about 50 to about 180° C., or about 60 to about 170° C., or about 70 to about 160° C.

Hereinafter, the disclosure will be described in further detail with reference to Preparation Examples, Examples, Comparative Examples and Experimental Examples, but the disclosure is not to be limited thereto.

### Preparation Example 1

### Synthesis of Dopamine-Bonded Hyaluronic Acid (MW 800)

Dopamine was dissolved in dimethylformamide (“DMF”), 1-ethyl-3-(3-dimethylaminopropyl)carbodiimide hydrochloride (“EDC”) was dissolved in methanol (MeOH), and polyethylenimine (“PEI”) was dissolved in MeOH. The dopamine was activated with the EDC for 30 minutes. The PEI was added to the solution. After 12 hours, the reaction product was precipitated twice with diethyl ester. Afterwards, the reaction product was dissolved in deionized water (pH 5 or lower), dialyzed with deionized water, and then freeze-dried.

### Preparation Example 2

### Synthesis of 3,4-Dihydroxy Benzoic Acid-Bonded PEI (MW 25,000)

3,4-dihydroxy benzoic acid was dissolved in DMF, EDC was dissolved in MeOH, and PEI was dissolved in MeOH. The 3,4-dihydroxy benzoic acid was activated with the EDC for 30 minutes. The PEI was added to the solution. After 12 hours, the reaction product was precipitated twice with diethyl ester. Afterwards, the reaction product was dissolved in deionized water (pH 5 or lower), dialyzed with deionized water, and then freeze-dried.

### Preparation Example 3

### Synthesis of Hydrocaffeinic Acid-Bonded PEI (MW 25,000)

Hydrocaffeinic acid was dissolved in DMF, the EDC was dissolved in MeOH, and PEI was dissolved in MeOH. The hydrocaffeinic acid was activated with the EDC for 30 minutes. The PEI was added to the solution. After 12 hours, the reaction product was precipitated twice with diethyl ester. Afterwards, the reaction product was dissolved in deionized water (pH 5 or lower), dialyzed with deionized water, and then freeze-dried.

### Examples 1 to 6

### Formation of Metal Ink Composition

Copper formate (Cu(HC(O)O)₂) was dissolved in hexyl amine (C₆H₁₅N) in an equivalent molar ratio (1:1), thereby preparing a first solution. Afterwards, as shown in Table 1, L-3,4-dihydroxyphenylalanine (“L-DOPA”; MW 197.188 g/mol) and adhesive materials according to Preparation Examples 1 to 3 were dissolved in water (H₂O) or ethylene glycol solvent, thereby preparing a second solution. The first solution was mixed with the second solution.

### Example 7

### Formation of Conductive Metal Film

The composition according to Examples 1 to 6 was coated on a glass substrate as a paste, and then uniformly spread using a doctor blade. In the ink, a layer was formed by spin-coating. The substrate was sintered at 200° C. for 1 minute in air, and then reduced at 200° C. for 2 minutes in a formic acid (HC(O)OH) atmosphere.

The ink composition according to the Examples did not condense or move, even when being immediately sintered at 200° C., and thus had excellent printability.

### Comparative Example 8

Copper formate (Cu(HC(O)O)₂) was dissolved in hexyl amine (C₆H₁₅N) in an equivalent molar ratio (1:1), thereby preparing a first solution. Afterwards, as shown in Table 1, ethyl cellulose was dissolved in N-methylpyrrolidone (“NMP”) solvent, thereby preparing a second solution. The first solution was mixed with the second solution.

The prepared ink composition was formed in a metal layer by the method described in Example 7. The metal film formed by the method according to Comparative Example was severely condensed in the middle when being immediately sintered at 200° C.

### Experimental Example 1

### Comparison of Adhesion

Conductive metal films formed using the Ink Compositions prepared according to Comparative Examples 1 to 7 and Examples 1 to 6 by the methods described in Comparative Example 8 and Example 7 were subjected to 3M tape peel tests at 180° C. according to ASTM D903-49. The results are listed in the following Table 1.

TABLE 1

| | | | Adhesive | 3M tape |
|---|---|---|---|---|
| | | | Material | peel test |
| Ink | Adhesive | | Content (Weight | (Pass/ |
| Composition | Material | Solvent | % to Copper) | Fail) |
| C. Example* 1 | Ethyl Cellulose | NMP | 4.884 | Fail |
| C. Example 2 | Ethyl Cellulose | NMP | 6.1 | Fail |
| C. Example 3 | Ethyl Cellulose | NMP | 6.5934 | Fail |
| C. Example 4 | Ethyl Cellulose | NMP | 7.326 | Fail |
| C. Example 5 | Ethyl Cellulose | NMP | 8.547 | Pass |
| C. Example 6 | Ethyl Cellulose | NMP | 9.768 | Pass |
| Example 1 | L-DOPA | EG | 4.884 | Pass |
| Example 2 | L-DOPA | EG | 6.1 | Pass |
| Example 3 | L-DOPA | H₂O | 4.884 | Pass |
| Example 4 | P. Example** 1 | EG | 4.884 | Pass |
| Example 5 | P. Example 2 | EG | 4.884 | Pass |
| Example 6 | P. Example 3 | EG | 4.884 | Pass |
| C. Example 7 | Polyethylimine | EG | 9.768 | Pass |

rf. C. Example*: Comparative Example
P. Example**: Preparation Example, weight % to Copper refers to weight of adhesive material versus the total weight of the metal particles and the metal precursor, if present.

Referring to Table 1, the Comparative Examples in which ethyl cellulose was added as an adhesive material failed the peel test because of a low adhesive strength unless the ethyl cellulose was added in a very high content. However, when L-DOPA, dopamine-grafted hyaluronic acid (MW 800), 3,4-dihydroxy benzoic acid-grafted PEI (MW 25,000), and hydrocaffeinic acid-grafted PEI (MW 25,000) were added according to the Examples, an alcohol such as EG or water was used. Even when the content of the adhesive material was relatively small at about 4.884 wt % to copper, it is shown that the Examples passed the peel test. Therefore, it observed that the ink compositions according to the Examples have sufficient adhesion when the adhesive material is added at a relatively small content.

### Experimental Example 2

### Comparison of Conductivity According to Type of Adhesive Material

Conductivity of the samples passing the peel test in Experimental Example 1, including the composition prepared by dissolving DOPA (4.884 wt %) in EG according to Example 4 and the compositions prepared by dissolving the compounds (4.884 wt %) of Preparation Examples 1 to 3 in EG according to Examples 4 to 6 was evaluated.

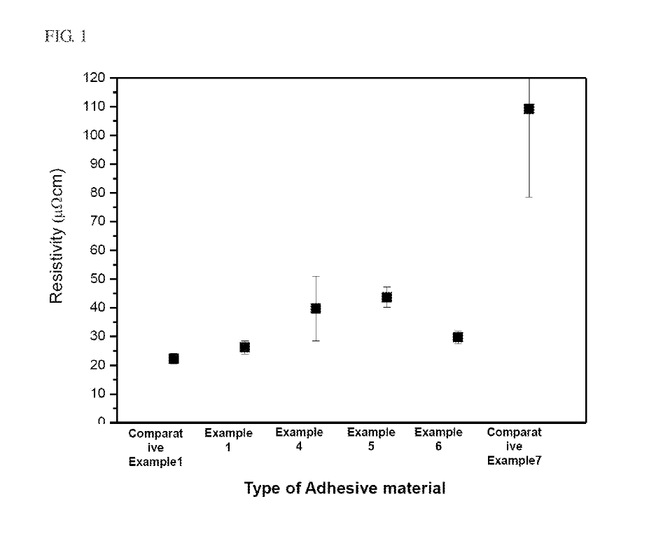

Further, conductivity of the ink composition prepared by dissolving ethyl cellulose (8.547 wt %) in NMP according to Comparative Example 5 and the ink composition prepared by dissolving PEI (9.768 wt %) in EG according to Comparative Example 7 was evaluated. The results are shown in FIG. 1.

Referring to FIG. 1, it is shown that adhesion and specific resistance of the ink compositions to which the adhesive materials according to Examples are added exhibited similar characteristics to those of the composition containing an industrially available polymer, ethyl cellulose, according to the Comparative Example. However, since the Comparative Example 7, to which only PEI is added, had the high resistance, it is confirmed that the conductivity was increased due to the graft with L-DOPA.

### Experimental Example 3

### Comparison of Conductivity According to Content of Adhesive Material

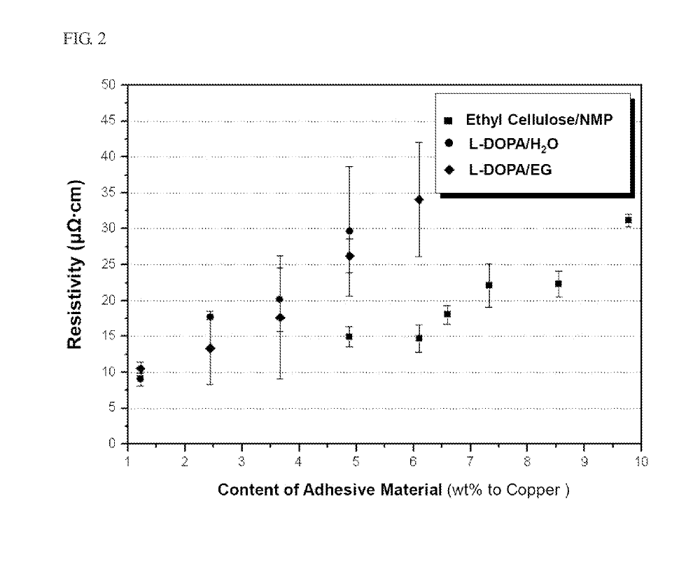

Conductivity of the samples passing the peel test in Experimental Example 1, including the ink composition prepared by dissolving ethyl cellulose in NMP according to Comparative Examples 1 to 6, the compositions prepared by dissolving DOPA in EG according to Examples 1 and 2, and the composition prepared by dissolving DOPA in water according to Example 3 was evaluated with various contents. The results are shown in FIG. 2. Comparative Examples were compared and evaluated after being cured at 60° C. for 2 minutes in air to prevent condensation during sintering.

Referring to FIG. 2, it is confirmed that the inks containing DOPA according to the Examples exhibited a similar level of conductivity even with a lower content of DOPA than the inks according to Comparative Examples.

While example embodiments have been disclosed herein, it should be understood that other variations may be possible. Such variations are not to be regarded as a departure from the spirit and scope of example embodiments, and all such modifications as would be recognized by one skilled in the art are intended to be included within the scope of the following claims.

What is claimed is:

1. A metal ink composition, comprising:
metal particles or a metal precursor,
a solvent, and
an organism-derived adhesive material.

2. The composition of claim 1, wherein the organism-derived adhesive material comprises a compound (A) of Formula 1, or a compound (B) having a structure in which a moiety derived from the compound (A) is chemically-bonded to a unit of the main chain of a water-soluble compound (b): 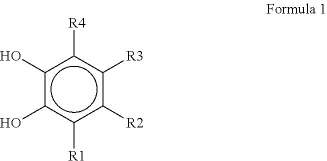
wherein R1, R2, R3, and R4 are each independently hydrogen or —R—X and two of R1, R2, R3, and R4 form a C₃-C₆ ring structure by bonding to each other,
each R being independently selected from C₁-C₁₀ alkyl, C₂-C₁₀ alkenyl, C₃-C₁₀ alkynyl, and C₁-C₁₀ alkoxy, each of which is unsubstituted or substituted with —OH or —COOH,
each —X being independently selected from —NR′R″, —COOR′, —NH₂COOR′, —CONR′R″, —OR′, phenyl, and benzyl, wherein R′ and R″ being each independently hydrogen or C₁-C₃ alkyl, and
wherein the two of R1, R2, R3, and R4 that form a ring structure by bonding to each other form a C₃-C₆ cycloalkyl, C₃-C₆ heterocycloalkyl, C₄-C₆ aryl, and C₄-C₆ heteroaryl, each of which is unsubstituted or substituted with —R—X, —OH or —COOH.

3. The composition of claim 2, wherein R in the compound (A) of Formula 1 is selected from C₁-C₅ alkyl, C₂-C₅alkenyl, C₃-C₅ alkynyl, and C₁-C₅ alkoxy, each of which is independently unsubstituted or substituted with —OH or —COOH, and X is —NH₂, —COOH, —NH₂COOR′R″, —C(O)NH, or —OH, each R′ and R″ being independently hydrogen or C₁-C₃ alkyl.

4. The composition of claim 2, wherein, in the compound (A) of Formula 1, R is selected from C₁-C₃ alkoxy, C₁-C₃ alkyl, and C₂-C₃ alkenyl, wherein each of the C₁-C₃ alkyl or the C₂-C₃ alkenyl is independently unsubstituted or substituted with —OH, and X is selected from —NH₂, —COOH, —NH₂COOH, and —OH.

5. The composition of claim 4, wherein the compound of Formula 1 is selected from compound of Formula (I) to Formula (xi):

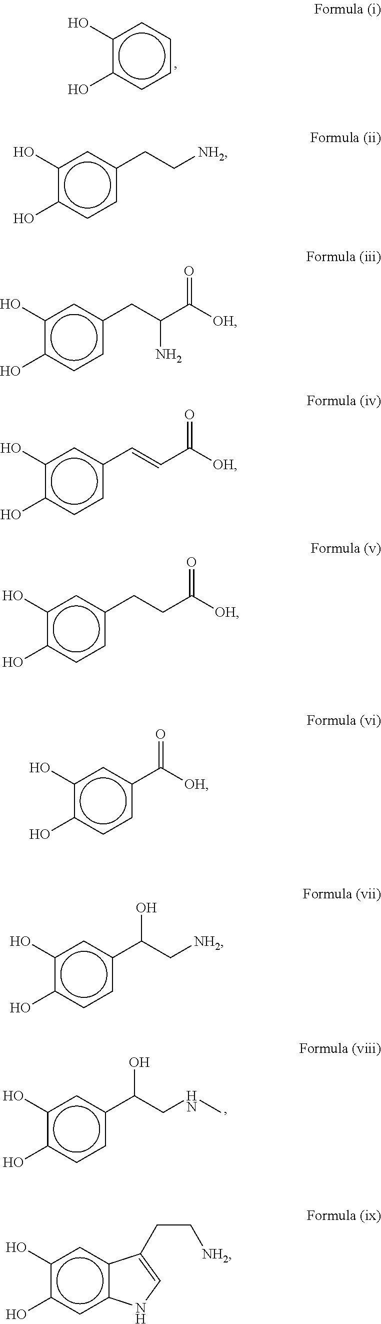

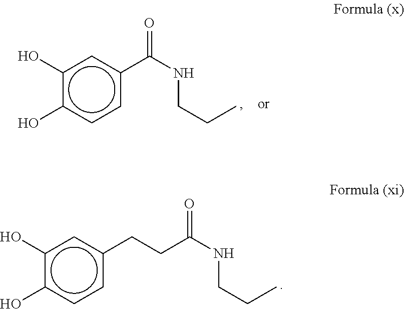

6. The composition of claim 1, wherein the organism-derived adhesive material is a material derived from a plant, fish, insect, crustacean, algae, yeast, fungi, protist, bacteria, virus, a protein derived from a cell or tissue of a human body, or a protein of a viscous material of an animal body.

7. The composition of claim 2, wherein the water-soluble compound (b) is miscible with a metal or a metal precursor, and is reactive with an amine, carboxyl, or hydroxyl group of the compound (A) of Formula 1.

8. The composition of claim 7, wherein the water-soluble compound (b) is selected from a hyaluronic acid, a polyethyleneimide, or a polyethyleneglycol.

9. The composition of claim 8, wherein the compound (B) is a dopamine-grafted hyaluronic acid, a 3,4-dihydroxy benzoic acid-grafted polyethyleneimide, or a hydrocaffeinic acid-grafted polyethyleneimide.

10. The composition of claim 2, wherein a content of the moiety derived from compound (A) in the compound (B) is about 0.1 to about 50 mole percent, based on the total moles of the moieties derived from the compound (A) and the total moles of the units derived from the water-soluble compound (b) of the compound (B).

11. The composition of claim 2, wherein the compound (A) of Formula 1 or the water-soluble compound (b) has a molecular weight or weight average molecular weight of about 100 to about 100,000 Daltons.

12. The composition of claim 2, wherein a content of the compound (A) of Formula 1 or a content of the compound (B) is about 3.7 to about 10 weight percent, based on the total weight of the metal particles and the metal precursor, if present.

13. The composition of claim 1, wherein a metal of the metal particles or the metal precursor is copper.

14. The composition of claim 1, wherein the metal precursor is a metal-organic compound, an organometallic compound, a metal oxide, a metal nitride, or a metal salt, or a combination thereof.

15. The composition of claim 14, wherein the metal salt comprises a metal halide, a metal sulfide, a metal hydroxide, or a metal carbonate, or a combination thereof.

16. The composition of claim 14, wherein the metal precursor is copper formate.

17. A method of forming a conductive metal film, the method comprising:
providing a substrate;
disposing the metal ink composition according to claim 1 onto the substrate to prepare a coated substrate; and
heating the coated substrate to form the conductive metal film.

18. The method of claim 17, wherein the disposing the metal ink composition comprises forming a pattern with the metal ink composition.

19. The method of claim 17, wherein the disposing the metal ink composition comprises spin coating, roll coating, deep coating, spray coating, dip coating, flow coating, doctor blade, dispensing, inkjet printing, screen printing, gravure printing, offset printing, pad printing, flexography printing, stencil printing, imprinting, xerography, or lithography.

20. A conductive metal film, comprising:
a substrate; and
a product of heating the metal ink composition of claim 1 on the substrate.
